(19) United States
(12) Patent Application Publication
(10) Pub. No.: US 2010/0208795 A1
(43) Pub. Date: Aug. 19, 2010

(54) REDUCING ALIASING IN SPATIAL SCALABLE VIDEO CODING

(75) Inventor: Shih-Ta Hsiang, Schaumburg, IL (US)

Correspondence Address: Motorola, Inc.;Law Department, 1303 East Algonquin Road, 3rd Floor, Schaumburg, IL, 60196, US

(73) Assignee: MOTOROLA, INC., Schaumburg, IL (US)

(21) Appl. No.: 12/705,266

(22) Filed: Feb. 12, 2010

Related U.S. Application Data
(60) Provisional application No. 61/153,955, filed on Feb. 19, 2009.

(51) Int. Cl. H04N 7/26

(52) U.S. Cl. 375/240.2; 375/240.26; 375/E07.078

(57) ABSTRACT

A system includes a first set of subband filter banks, a second set of subband filter banks, a low-resolution base encoder, and a high-resolution enhancement encoder. The first set of subband filter banks performs subband analysis on a full resolution source video frame to generate a subband representation comprised of a lowpass subband and multiple highpass subbands. The second set of the filter banks decomposes the lowpass subband into aliasing subband components and aliasing-free subband components. The low-resolution encoder encodes the aliasing-free subband components, to generate an encoded video signal with minimal or no aliasing subband components. The highpass subbands from the first set of filter banks, the aliasing subband components, and optional refinements of aliasing-free subband components are encoded by the high-resolution enhancement encoder to provide further information for recovering video at full resolution.

### PRIORITY

This application claims priority to U.S. provisional patent application Ser. No. 61/153,955, filed Feb. 19, 2009, by Shih-Ta Hsiang, and entitled “Spatial Scalable Subband/Wavelet Video Coding With Reduced Aliasing Artifacts”, which is incorporated by reference in its entirety.

### BACKGROUND

Spatial scalable coding allows a coded image or video signal to be efficiently recovered at several different spatial resolutions from a single scalable code-stream. Spatial scalable coding has become increasingly useful for diverse video applications over a heterogeneous environment. Video coding standards such as MPEG-2/4, H.263+ and the emerging H.264/AVC scalable video coding (SVC) adopt a pyramidal approach to spatial scalable coding. However, the number of source pixel samples is increased by 33.3% for building a complete image pyramidal representation, which can inherently reduce compression efficiency.

Alternatively, current coders using subband/wavelet coding have been demonstrated to be highly efficient for image compression. Subband/wavelet coding has also been utilized in the international standard JPEG 2000 for image and video (in the format of Motion JPEG 2000) coding applications in industry. Because of high energy compaction of subband/wavelet transform, these current coders are capable of achieving excellent compression performance without traditional blocky artifacts associated with the block transform. More importantly, the current coders can easily accommodate the desirable spatial scalable coding functionality with almost no penalty in compression efficiency because the subband/wavelet decomposition is resolution scalable by nature. However, because the subband/wavelet analysis lowpass filter is not a perfect half band filter, aliasing artifacts are introduced in the resulting low-resolution signal, which can be particularly disturbing for video coding applications.

### SUMMARY

Disclosed herein is a spatial scalable subband/wavelet coding system with reduced aliasing in the decoded low resolution video. The system includes a first set of subband/wavelet filter banks, a second set of subband/wavelet filter banks, a low-resolution base encoder, and a high-resolution enhancement encoder. The first set of subband/wavelet filter banks performs subband/wavelet analysis on a full resolution source video frame to generate a subband representation comprised of a lowpass subband and multiple highpass subbands. The second set of the filter banks decomposes the lowpass subband into aliasing subband components and aliasing-free subband components. The low-resolution encoder encodes the aliasing-free subband components, to generate an encoded video signal with minimal or no aliasing subband components. The highpass subbands from the first set of filter banks and the aliasing subband components and optional refinements of aliasing-free subband components are encoded by the high-resolution enhancement encoder to provide further information for recovering video at full resolution.

Also disclosed herein is a method for reducing aliasing in decoded low-resolution video. In the method, a full resolution source video frame in an input video sequence is received at a first set of subband/wavelet analysis filter banks. Subband/wavelet analysis is performed on the full resolution source video frame to generate a subband representation comprised of a lowpass subband and multiple highpass subbands. The lowpass subband is decomposed into aliasing-free subband components and aliasing subband components using a second set of subband/wavelet analysis filter banks. The aliasing-free subband components are encoded to generate a base-layer bitstream using a low resolution encoder.

Still further disclosed is a computer readable storage medium on which is embedded one or more computer programs implementing the above-disclosed method for reducing aliasing in decoded low-resolution video, according to an embodiment.

Embodiments of the present invention provide a subband/wavelet spatial scalable coding system and method with reduced aliasing artifacts in recovered lower-resolution video. The system and method thereby provide improved performance when compared to a conventional subband/wavelet coding system in compression efficiency and visual quality for decoding at lower resolution while retaining overall performance at full resolution. Embodiments of the invention are applied to the individual video frame and can also be applied to spatial scalable subband/wavelet image coding.

### BRIEF DESCRIPTION OF THE DRAWINGS

Features of the present invention will become apparent to those skilled in the art from the following description with reference to the figures, in which:

FIG. 1 illustrates a simplified block diagram of a system for reducing aliasing in spatial scalable subband/wavelet coding at low resolution, according to an embodiment of the invention;

FIG. 2 illustrates a simplified block diagram of separable subband/wavelet filter banks, according to an embodiment of the invention;

FIG. 3 illustrates a subband partition for decomposed frame, according to an embodiment of the invention;

FIG. 4A illustrates high frequency aliasing subband components filtered by a subband filter, according to an embodiment of the invention;

FIG. 4B illustrates high frequency aliasing subband components filtered by a subband filter, according to another embodiment of the invention;

FIG. 5 shows a block diagram of a spatial scalable subband/wavelet coding system with reduced aliasing, according to an embodiment of the invention; and

FIG. 6 shows a flow diagram of a spatial scalable subband/wavelet coding method with reduced aliasing, according to an embodiment of the invention; and

FIG. 7 shows a flow diagram of a method for reducing aliasing in coding, according to an embodiment of the invention.

### DETAILED DESCRIPTION

For simplicity and illustrative purposes, the present invention is described by referring mainly to exemplary embodiments thereof. Multiple embodiments may be used in combination with each other. In the following description, numerous specific details are set forth to provide a thorough understanding of the present invention. However, it will be apparent to one of ordinary skill in the art that the present invention may be practiced without limitation to these specific details. In other instances, well known methods and structures have not been described in detail to avoid unnecessarily obscuring the present invention.

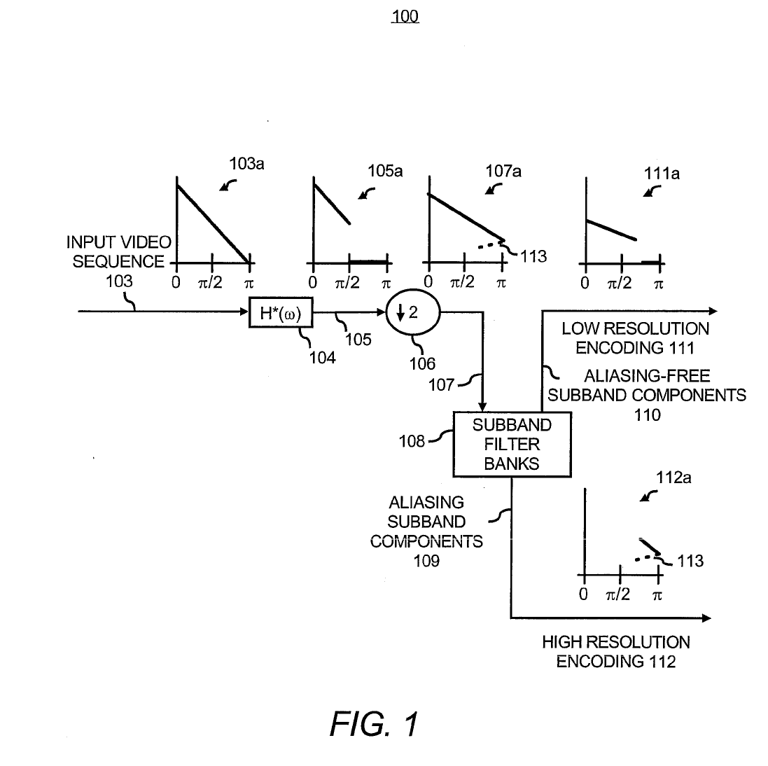

FIG. 1 illustrates a simplified block diagram of a system for reducing aliasing in spatial scalable subband/wavelet coding at low resolution, according to an embodiment. Coding as used herein may include encoding and/or decoding. FIG. 1 shows encoding a video signal with a focus on processing the lowpass subband signal component. In summary, the system 100 includes a first set of subband analysis filter banks and a second set of subband analysis filter banks 108. The first set of subband analysis filter banks includes a subband analysis lowpass filter (H*(ω)) 104, and a down-sampler 106. Similar to a conventional subband/wavelet coding system, the input video sequence 103 is first decomposed by subband filter banks into a subband representation. To generate the lowpass subband, the subband analysis lowpass filter 104 is configured to lowpass filter the input video sequence 103 to form a lowpass filtered signal 105 and the down-sampler 106 is configured to down-sample the lowpass filtered signal 105 to form a lowpass subband signal 107. The second set of subband filter banks 108 further decompose the lowpass subband signal 107 into aliasing subband components 109 and aliasing-free subband components 110. It should be understood that the system 100 depicted in FIG. 1 may include additional components and that some of the components described herein may be removed and/or modified without departing from a scope of the system 100.

The details of the system 100 are now described. As shown in FIG. 1, the input video sequence 103 represents a full resolution video signal. The energy spectrum in one spatial dimension is shown for each of the signals generated in each of the stages of the system 100. The energy spectrum 103a of the input video sequence 103, for example, includes frequency components across the entire frequency range between 0 and π.

For generating the lowpass subband, the input video sequence 103 is first input to the subband analysis lowpass filter 104, generating the lowpass filtered signal 105. The lowpass filtered signal 105 is thereafter down sampled (e.g., by a factor of 2 in each spatial dimension) using the down-sampler 106 to generate the lowpass subband signal 107. Because the subband analysis lowpass filter 104 is not a perfect half band filter, aliasing subband components 113 are introduced in the lowpass subband signal 107, which are shown in the energy spectrum 107a for the lowpass subband signal 107. Note that the aliasing subband components 113 are distributed around the high frequency range.

The lowpass subband signal 107 is then further processed by a second set of subband analysis filter banks 108. The second set of subband filter banks 108 separates the low-frequency aliasing-free subband components 110 from the high-frequency aliasing subband components 109. The aliasing-free subband components are then encoded, shown as 111, to generate a low resolution encoded video signal, which may be used as the base signal or layer 0 signal of an SVC signal. The remaining aliasing subband components 109 are combined with the next higher resolution subbands (not shown), and are encoded, shown as 112, in the next higher resolution layer, such as layer 1 of an SVC signal.

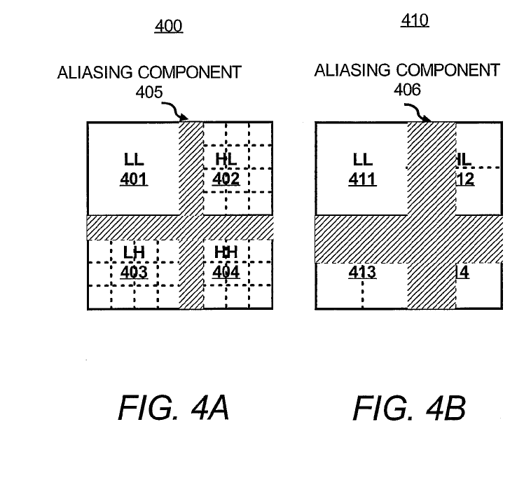

According to an example, the second set of subband filter banks 108, shown in FIG. 1, may consist of a one-stage discrete wavelet transform (DWT) cascaded with a H.264/AVC 4×4 discrete cosine transform (DCT) further performed on each highpass subband, providing finer subband partitioning and improved frequency selectivity. The resulting subband partition 400 using this subband filter banks 108 is illustrated in FIG. 4A. The output aliasing subband components 109 of the second set of subband filter banks 108 correspond to the aliasing subband components 405 indicated by the slash line regions in FIG. 4A. These are high frequency components of the lowpass subband signal as indicated by the spectrum of the aliasing subband components 113, as shown in FIG. 1.

According to another example, the second set of subband filter banks 108 may consist of the one-stage DWT cascaded with another one-stage DWT performed on each highpass subband, leading to a dead-zone size of approximately π/4 in the spectrum of the resulting aliasing-free subband components 110. A resulting subband partition 410 using this second set of subband filter banks 108 is illustrated in FIG. 4B. The output aliasing subband components 109 of the second set of subband filter banks 108 correspond to the aliasing subband components 406 indicated by the slash line regions in FIG. 4B.

The aliasing-free components 110, representing the decomposed source signal at low-resolution, are then subject to low-resolution encoding 111 by a low-resolution encoder (not shown) to form an encoded aliasing free signal as described with respect to FIG. 1. However, the aliasing subband components 109, combined with a set of next higher resolution subbands, are subject to high-resolution encoding 112 in a next higher resolution layer (not shown). The next higher resolution layer and the encoded aliasing free signal may be thereafter multiplexed to form the scalable video.

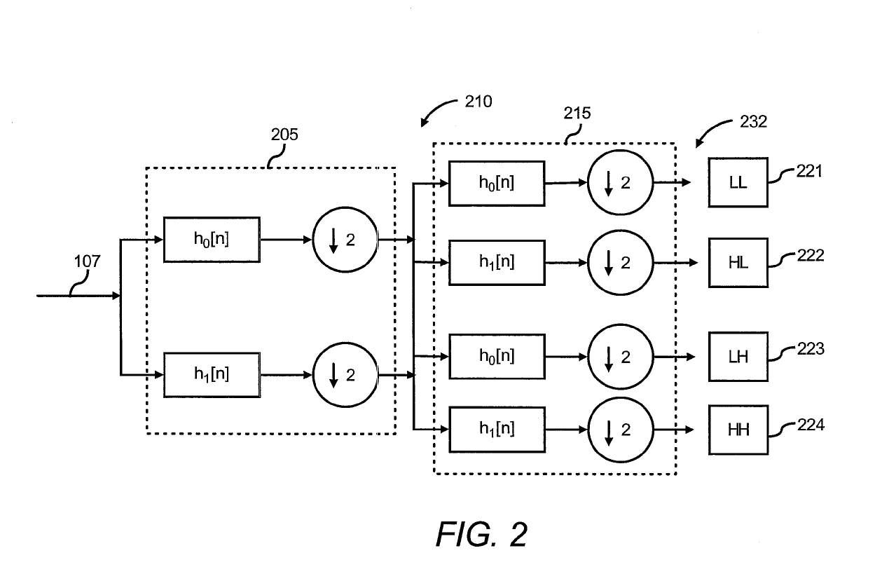

FIG. 2 is a block diagram illustrating the separable second set of subband/wavelet filter banks 108 (FIG. 1), according to an embodiment. An input video frame is first respectively processed by a lowpass analysis filter (h0[n]) and a highpass analysis filter (h1[n]) followed by a down-sampling operation along the vertical direction, generating intermediate signals 210. The intermediate signals 210 are then respectively processed by a lowpass analysis filter and a highpass analysis filter followed by a down sampling operation along the horizontal direction, generating the four subbands (LL 221, HL 222, LH 223, and HH 224) for the version of the video frame at the particular resolution. This process is commonly referred to as wavelet/subband decomposition. The filters used in the subband filter banks 106 may belong to a family of wavelet filters or a family of quadrature mirror filter (QMF) filters. The subband decomposition operation in FIG. 1 can be recursively applied to the lowpass subband LL from the previous decomposition stage to form a multi-resolution representation. In an SVC system, each set of subbands for representing the current resolution level can be synthesized to form the LL subband of the next higher level of resolution.

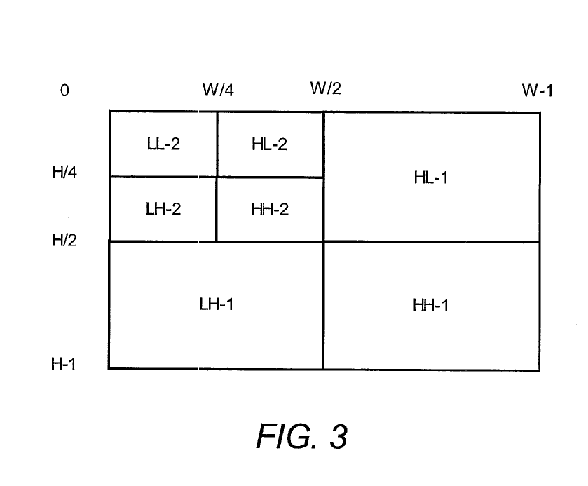

FIG. 3 shows different layers of a SVC signal representation, including subbands in each decomposition level. This aspect is illustrated by FIG. 3, in which the subbands of the highest resolution layer are indicated by the suffix -1, and in which the base or lowest layer is LL-2. H and W stand for, respectively, for height and width of the full resolution video frame. The height and width are measured from 0 to H-1 and from 0 to W-1 respectively.

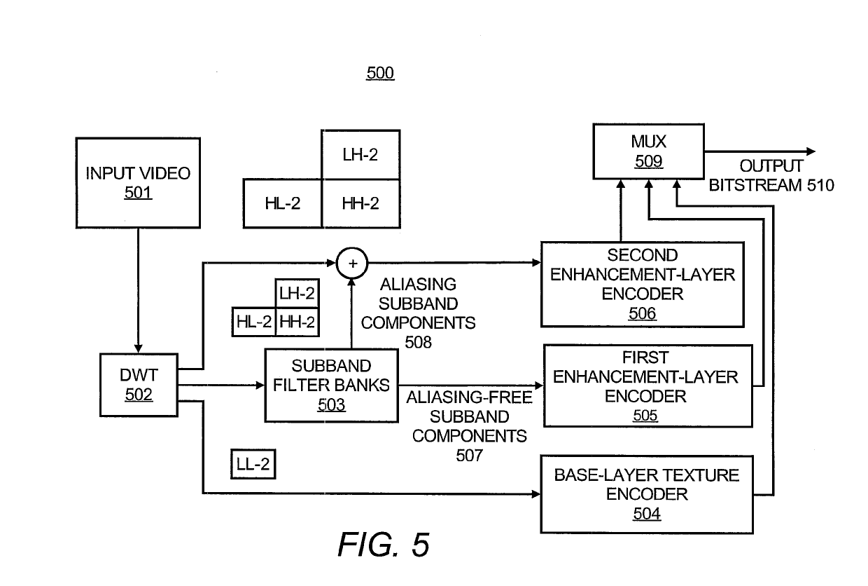

The current system may be integrated with the H.264/AVC SVC system, as defined in Annex G of the H.264/AVC international standard, for intra-frame subband/wavelet video coding. As such, the current system can be effectively implemented by re-using many existing standard coding tools. FIG. 5 is a block diagram illustrating an embodiment of the current system 500 utilizing the H.264/AVC SVC tools for intraframe video coding. As shown in FIG. 5 the system 500 includes a DWT 502, subband filter banks 503, a base layer texture encoder 504, a first enhancement-layer encoder 505, a second enhancement-layer encoder 506 and a multiplexer (mux) 509. The system 500 thereby provides spatial scalable coding with improved performance. The system 500 is illustrated for spatial scalable coding in three layers, with the aliasing artifacts removed in a second resolution layer. It should be understood that the system 500 depicted in FIG. 5 may include additional components and that some of the components described herein may be removed and/or modified without departing from a scope of the system 500.

According to an embodiment, as shown in FIG. 5, an input video signal 501 is decomposed by the DWT 502 using a two-stage forward discrete wavelet transform. A resulting lowest frequency subband is then encoded as a H.264/AVC compatible bitstream, in accordance with the current H.264/AVC scalable extension, using a low-resolution encoder, for instance the base layer texture encoder 504. At a next higher resolution, the subband filter banks 503 further decomposes each highpass subband into aliasing-free subband components 507 and aliasing subband components 508. The alias-free components 507 are then encoded at a first enhancement-layer (not shown) using the first H.264/AVC SVC enhancement-layer encoder 505. The aliasing subband components 308 are combined with the highest frequency subbands and encoded at a high resolution enhancement encoder, for instance a second H.264/AVC SVC enhancement-layer encoder into a second enhancement-layer (a full-resolution layer in three layer scalable video). The low-resolution encoder and the high resolution enhancement encoder comprise Intra Slice coding tools defined in H.264/MPEG4 AVC standard.

It will be apparent that the systems 100 and 500 may include additional elements not shown and that some of the elements described herein may be removed, substituted and/or modified without departing from the scope of the systems 100 and 500. It should also be apparent that one or more of the elements described in the embodiment of FIGS. 1 and 5 may be optional.

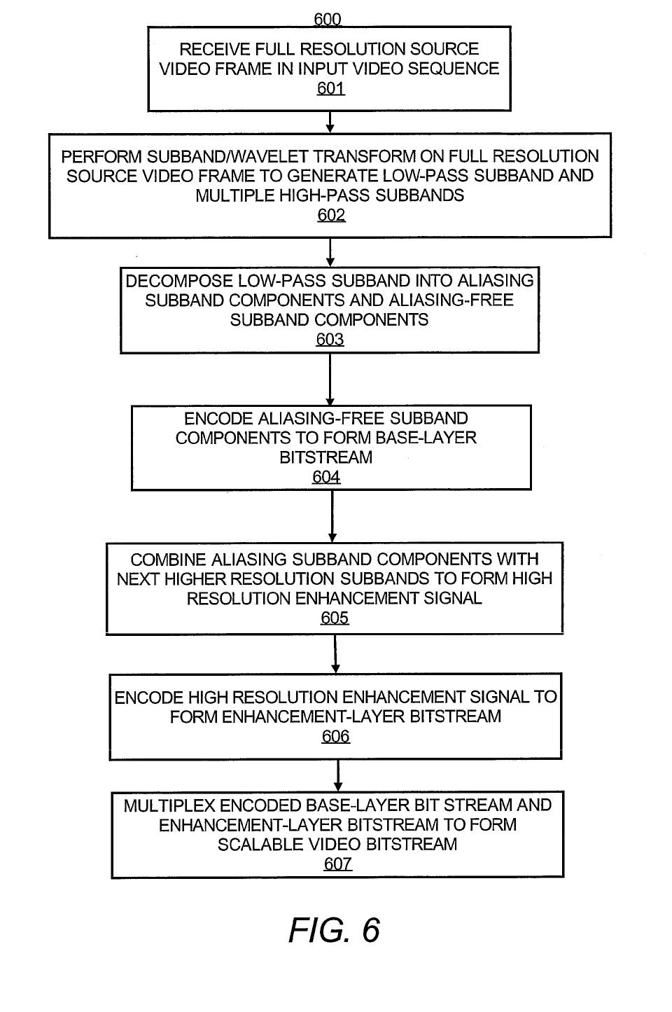

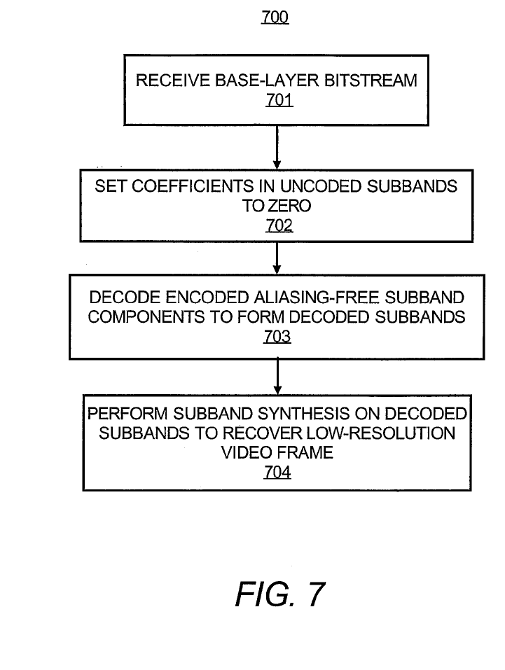

An example of a method in which the systems 100 and 500 may be employed for reducing aliasing in coding now be described with respect to the following flow diagram of the methods 600-700 depicted in FIGS. 6-7. It should be apparent to those of ordinary skill in the art that the methods 600-700 represent a generalized illustration and that other steps may be added or existing steps may be removed, modified or rearranged without departing from the scopes of the methods 600-700. Also, the methods 600-700 are described with respect to the systems 100 and 500 by way of example and not limitation, and the methods 600-700 may be used in other systems.

Some or all of the operations set forth in the methods 600-700 may be contained as one or more computer programs stored in any desired computer readable medium and executed by a processor on a computer system. Exemplary computer readable media that may be used to store software operable to implement the present invention include but are not limited to conventional computer system RAM, ROM, EPROM, EEPROM, hard disks, or other data storage devices.

At step 601, the first set of subband filter banks receives a full resolution source video frame in an input video sequence 103. The first set of subband analysis filter banks includes a subband analysis lowpass filter 104, and a down-sampler 106. The input video sequence 103 may be comprised of multiple source video frames.

Thereafter, at step 602, the first set of subband filter banks performs a subband/wavelet transform on the full resolution source video frame to generate a subband representation of the full resolution source video frame. The subband representation includes a lowpass subband and multiple highpass subbands.

At step 603, the second set of subband filter banks 108 decomposes the lowpass subband generated in step 602 hereinabove into aliasing subband components and aliasing-free subband components.

According to an embodiment, the second set of subband filter banks 108 may form part of a system integrated with an H.264/AVC SVC extension such as the system 500. The second set of subband filter banks 108 may perform a one-stage DWT on the lowpass subband to form a DWT lowpass subband and three highpass subbands at the next decomposition level. The second set of subband filter banks 108 may perform a 4×4 DCT on each of the three highpass subbands at the next decomposition level. The second set of subband filter banks 108 may filter the low-resolution signal 107 using a filter as shown in FIG. 4B.

According to another embodiment, the second set of subband filter banks 108 performs a one stage DWT on the lowpass subband to form a DWT lowpass subband and three highpass subbands at the next decomposition level. Thereafter the second set of subband filter banks 108 performs a one-stage DWT on each of the three highpass subbands at the next decomposition level. The subband filter banks 108 in this instance may filter the low-resolution signal 107 as shown in FIG. 4A.

At step 604, the aliasing-free subband components 110 are encoded using a low-resolution encoder to form a base-layer bitstream (not shown).

At step 605, the aliasing subband components may be combined with next higher resolution subbands to form a high resolution enhancement signal. For instance, as described with respect to FIG. 4, the aliasing subband components may be combined with subbands LH-1, HL-1, and HH-1. Thereafter, at step 608, the combined aliasing subband may be encoded in the next higher resolution layer to form the high resolution enhancement signal.

At step 606, the high resolution enhancement signal may be encoded to form an enhancement-layer bitstream (not shown).

At step 606, the enhancement-layer bitstream and the base-layer bitstream may be multiplexed, using for instance the mux 509 in FIG. 5, with the encoded aliasing-free signal to form a scalable video bitstream (not shown).

The method 700 provides a process of decoding the encoded aliasing-free signal to form low resolution video or a low resolution frame.

At step 701, a low-resolution decoder (not shown) receives the base-layer bitstream. For instance, the system 500 as shown in FIG. 5, may send the scalable video bitstream after multiplexing. The base-layer bitstream may be received after demultiplexing the scalable video bitstream. The base-layer bistream comprises aliasing-free subband components and uncoded subbands.

At step 702, the low resolution decoder sets coefficients in the uncoded subbands to zero.

At step 703, the low resolution decoder decodes the encoded aliasing-free subband components to form decoded subbands. Thereafter, at step 704, the low resolution decoder performs subband synthesis on the decode subbands to recover a low resolution video frame. The low-resolution video frame may have minimal or no aliasing subband components.

Embodiments of the present invention provide a subband/wavelet spatial scalable coding system and method with reduced aliasing artifacts in recovered lower-resolution video. The system and method thereby provides improved performance when compared to a conventional subband/wavelet coding system in compression efficiency and visual quality for decoding at lower resolution while retaining overall performance at full resolution.

Although described specifically throughout the entirety of the instant disclosure, representative embodiments of the present invention have utility over a wide range of applications, and the above discussion is not intended and should not be construed to be limiting, but is offered as an illustrative discussion of aspects of the invention.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the invention, wherein the invention is intended to be defined by the following claims—and their equivalents—in which all terms are mean in their broadest reasonable sense unless otherwise indicated.

What is claimed is:

1. A system for spatial scalable subband coding with reduced aliasing in decoded low-resolution video, the system comprising:
a first set of subband analysis filter banks configured
to receive a full resolution source video frame in an input video sequence, and
to perform subband analysis on the full resolution source video frame, generating a lowpass subband and multiple highpass subbands;
a second set of subband analysis filter banks configured to decompose the lowpass subband into aliasing-free subband components and aliasing subband components; and
a low-resolution encoder configured to encode the aliasing-free subband components and generate a base-layer bitstream.

2. The system of claim 1, further comprising:
a high resolution enhancement encoder configured,
to combine the aliasing subband components and optional refinements of aliasing-free subband components with the multiple highpass subbands to form a combined high resolution enhancement signal; and
to encode the combined high resolution enhancement signal to generate an enhancement-layer bitstream.

3. The system of claim 1, further configured to decompose the low resolution video into more lower resolution layers by recursively treating the low-resolution aliasing-free signal from the previous stage as the full resolution source video frame in the input video sequence of claim 1.

4. The system of claim 1, wherein the second set of subband filter banks comprises
a one-stage discrete wavelet transform (DWT) performed on the lowpass subband to form a lowpass subband and three highpass subbands at the next decomposition level; and
a 4×4 discrete cosine transform (DCT) performed on each of the three highpass subbands at the next decomposition level.

5. The system of claim 1, wherein the second set of subband filter banks comprises
a one-stage DWT performed on the lowpass subband to form a lowpass subband and three highpass subbands at the next decomposition level; and
a one-stage DWT performed on each of the three highpass subbands at the next decomposition level.

6. The system of claim 2, wherein the low-resolution encoder and the high resolution enhancement encoder comprise Intra Slice coding tools defined in H.264/MPEG4 AVC standard.

7. The system of claim 1, further comprising:
a low-resolution decoder, configured to
receive the base-layer bitstream;
set all coefficients in uncoded subbands to zero;
decode the encoded aliasing-free subband signal components; and
perform subband synthesis to recover a low-resolution video frame.

8. A method for spatial scalable subband coding with reduced aliasing in decoded low-resolution video, the method comprising:
receiving a full resolution source video frame in an input video sequence at a first set of subband analysis filter banks;
performing subband analysis on the full resolution source video frame to generate a lowpass subband and multiple highpass subbands;
decomposing the lowpass subband into aliasing-free subband components and aliasing subband components using a second set of subband analysis filter banks; and
encoding the aliasing-free subband components to generate a base-layer bitstream using a low resolution encoder.

9. The method of claim 8, further comprising:
combining the aliasing subband components and optional refinements of aliasing-free subband components with the multiple highpass subbands to form a combined high resolution enhancement signal; and
encoding the combined high resolution enhancement signal to generate an enhancement-layer bitstream.

10. The method of claim 8, further comprising:
decomposing the low resolution video into more lower resolution layers by recursively treating the low-resolution aliasing-free signal from the previous stage as the full resolution source video frame in the input video sequence of claim 8.

11. The method of claim 8, wherein further decomposing the lowpass subband comprises:
performing a one stage DWT on the lowpass subband to form a DWT lowpass subband and three highpass subbands at the next decomposition level; and
performing a 4×4 DCT on each of the three highpass subbands at the next decomposition level.

12. The method of claim 8, wherein further decomposing the lowpass subband comprises:
performing a one stage DWT on the lowpass subband to form a DWT lowpass subband and three highpass subbands at the next decomposition level; and
performing a one-stage DWT on each of the three highpass subbands at the next decomposition level.

13. The method of claim 8,
receiving the base-layer bitstream at a low-resolution decoder;
setting all coefficients in uncoded subbands to zero;
decoding the encoded aliasing-free subband signal components; and
performing subband synthesis to recover a low-resolution video frame.

14. A computer readable storage device on which is embedded one or more computer programs, said one or more computer programs, when executed by a computer system, implementing a method for reducing aliasing in decoded low-resolution video, said one or more computer programs comprising a set of instructions for:
receiving a full resolution source video frame in an input video sequence using a first set of subband analysis filter banks;
performing subband analysis on the full resolution source video frame to generate a lowpass subband and multiple highpass subbands;
further decomposing the lowpass subband into aliasing aliasing-free subband components and aliasing subband components using a second set of subband analysis filter banks; and
encoding the aliasing-free subband components to generate a base-layer bitstream using a low resolution encoder.

15. The computer readable storage device according to claim 14, further comprising instructions for:
combining the aliasing subband components and optional refinements of aliasing-free subband components with the multiple highpass subbands to form a combined high resolution enhancement signal; and
encoding the combined high resolution enhancement signal to generate an enhancement-layer bitstream.

16. The computer readable storage device according to claim 14, further comprising instructions for:
decomposing the low resolution video into more lower resolution layers by recursively treating the low-resolution aliasing-free signal from the previous stage as the full resolution source video frame in the input video sequence of claim 8.

17. The computer readable storage device according to claim 14, wherein further decomposing the lowpass subband comprises:
performing a one stage DWT on the lowpass subband to form a DWT lowpass subband and three highpass subbands at the next decomposition level; and
performing a 4×4 DCT on each of the three highpass subbands at the next decomposition level.

18. The computer readable storage device according to claim 14, wherein further decomposing the lowpass subband comprises:
performing a one stage DWT on the lowpass subband to form a DWT lowpass subband and three highpass subbands at the next decomposition level; and
performing a one-stage DWT on each of the three highpass subbands at the next decomposition level.

19. The computer readable storage device according to claim 14, further comprising instructions for:
receiving the base-layer bitstream at a low-resolution decoder;
setting all coefficients in uncoded subbands to zero;
decoding the encoded aliasing-free subband signal components; and
performing subband synthesis to recover a low-resolution video frame.
